(19) United States
(12) Patent Application Publication
(10) Pub. No.: US 2026/0236484 A1
(43) Pub. Date: Aug. 13, 2026

(54) NUCLEAR REACTOR CODE-TO-CODE COMPARISON SYSTEM

(71) Applicant: Board of Regents, The University of Texas System, Austin, TX (US)

(72) Inventors: Harrison Reisinger, Austin, TX (US); Ondrej Chvala, Austin, TX (US); Soha Aslam, Austin, TX (US); Kevin Clarno, Austin, TX (US); Trevor Van Husen, Austin, TX (US)

(21) Appl. No.: 19/532,332

(22) Filed: Feb. 6, 2026

Related U.S. Application Data
(60) Provisional application No. 63/755,445, filed on Feb. 7, 2025.

(51) Int. Cl. G06F 16/25; G06F 16/10; G06F 16/22; G06F 16/28

(52) U.S. Cl. CPC G06F 16/258; G06F 16/10; G06F 16/2246; G06F 16/283

(57) ABSTRACT

A simulation tool is present to perform code-to-code comparisons of neutronics results using SCALE, Serpent, and OpenMC. The simulation tool is configured to read input data objects from a reactor model and convert the data objects into different input files in accordance with syntax rules of neutronic codes, including, but not limited to, SCALE, Serpent, and OpenMC.

### RELATED APPLICATION

The present application relates and claims priority to U.S. Provisional Application No. 63/755,445, filed on Feb. 7, 2025, which is hereby incorporated by reference in its entirety.

### TECHNICAL FIELD

The described examples relate generally to systems, methods, and techniques for performing code-to-code comparisons of neutronics results with identical inputs by using different reactor simulation tools.

### BACKGROUND

Molten salt reactors (MSRs) offer an approach to nuclear power that utilizes molten salts as their nuclear fuel in place of the conventional solid fuels used in light water reactors. Advantages may include efficient fuel utilization and enhanced safety (in part due to replacing water as a coolant with molten salt). They differ from conventional nuclear reactors in that the fuel is a molten fuel salt. This fissile mixture circulates through a loop where, in the core, it passes through a moderating region and becomes critical.

An example Molten Salt Research Reactor (MSRR) may include a small, 1MWₜₕ, research reactor. Previous molten salt reactors include Oak Ridge National Laboratory's (ORNL) Molten Salt Reactor Experiment (MSRE). The MSRR may include a fissile component, uranium tetrafluoride (UF₄), and a base FLiBe (2LiF—BeF₂) salt and use the same fuel and coolant LiF·BeF₂ (Flibe) salts; however, the uranium will be enriched to below 20%, and the molar fraction of UF4 will be increased to ≈5%.

One purpose of the MSRR, or research reactors in general, is to provide data for validation of nuclear reactor modeling codes that would support the licensing of commercial reactors. Numerous simulation tools or neutronic codes have been used to analyze the design and performance of the MSRE, such as SCALE code system developed by Oak Ridge National Laboratory (ORNL), Serpent, OpenMC, and MCNP. These tools or codes were compared for MSRE and were shown to have reasonable agreement with one another and, for the predictions relevant to reactor safety, the experimental data from the reactor model operation. However, there exist some limitations on the neutronics calculations that are used to support the licensing of contemplated MSRs, including criticality safety, startup physics testing, normal operation, source-term analysis, shielding and dosimetry throughout the facility, and data to support safety analysis calculations. For example, lacking a currently operational MSR may impose challenges in validating neutronics calculations and simulations. Performing accurate neutronics calculations and simulations may require significant computational resources, including high-performance computing systems. This may also be a limiting factor, especially for some smaller research institutions. In addition, due to the different inputs of SCALE, Serpent, OpenMC, and MCNP, it is difficult to model the same geometry and materials using these simulation tools or neutronic codes. Therefore, it is necessary to develop a simulation tool for converting a reactor model's configurations and parameters into different input files that are compatible with different simulation tools or neutronic codes.

### SUMMARY

In one example, a computer-implemented method for facilitating nuclear reactor simulation on identical parameters of the reactor is disclosed. The method comprises receiving, via an input interface, a plurality of objects describing geometry data and material data associated with a plurality of components in a nuclear reactor model. The method also comprises generating, via a processor, a hierarchical tree structure, wherein the hierarchical tree structure comprises a plurality of nodes representing the plurality of objects. Each node stores geometry data and material data associated with a respective component of the nuclear reactor model. The method teaches that a plurality of parent-child relationships are formed between the plurality of nodes to represent relationships between the plurality of components. A processor is used to convert the hierarchical tree structure into a first data format by parsing the geometry data and the material data throughout the hierarchical tree structure and encoding the geometry data and the material data based on syntax associated with the first data format. Then the processor is used to generate a first output file to contain the encoded geometry data and the material data.

In certain embodiments, the method comprises converting the hierarchical tree structure into a second data format by parsing the geometry data and the material data throughout the hierarchical tree structure and encoding the geometry data and the material data based on syntax associated with the second data format, wherein the syntax associated with the second data format is different from the syntax associated with the first data format. The processor is used to generate a second output file to contain the encoded geometry data and the material data. The method may also comprise transmitting, via an output interface, the first output file to a first nuclear reactor simulation tool and the second output file to a second nuclear reactor simulation tool.

In some embodiments, the method comprises converting the hierarchical tree structure into a third data format by parsing the geometry data and the material data throughout the hierarchical tree structure and encoding the geometry data and the material data based on syntax associated with the third data format, wherein the syntax associated with the third data format is different from the syntax associated with the first and second data formats. The processor is then used to generate a third output file to contain the encoded geometry data and the material data.

In another example, the first data format is compatible with an input file of SCALE.

In another example, the second data format is compatible with an input file of Serpent.

In another example, the third data format is compatible with an input file OpenMC.

In addition to the embodiments described above, further aspects and examples will become apparent by reference to the drawings and by study of the following description.

### BRIEF DESCRIPTION OF THE DRAWINGS

FIG. 1 depicts an example input file creation process.

FIG. 2 depicts an example material type representation for creating a material data object.

FIG. 3 depicts an example code for initializing components with materials.

FIG. 4 depicts an example code for extracting mixture numbers from the model object.

FIG. 5 depicts an example table with preset definitions for a settings object.

FIG. 6 depicts a flow diagram of an example process for creating input files in accordance with different syntax rules of simulation tools.

FIG. 7 depicts a functional block diagram of a computing system.

FIG. 8 depicts an example flux comparison figure and an example comparison of Pincell Models in Serpent, SCALE, and OpenMC.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described invention may be practiced in a variety of forms in addition to those described herein.

The following disclosure relates generally to a simulation tool used to create neutronics inputs for design and licensing of various molten salt reactors. As used herein, said simulation tool shall be referred to as “NaNuC Simulation Tool”. The NaNuC Simulation Tool may be used to perform code-to-code comparisons of neutronics results using various simulation tools, including SCALE, Serpent, and OpenMC. The NaNuC Simulation Tool may be used with molten salt reactors that are small, 1MWₜₕ, research reactors, for example, which may be designed to be a smaller, simpler, and safer newer version of Oak Ridge National Laboratory's (ORNL) Molten Salt Reactor Experiment (MSRE). As generally contemplated herein, such molten salt reactors for use with the NaNuC Simulation Tool may use the same fuel and coolant LiF·BeF₂ (Flibe) salts; however, the uranium will be enriched to below 20%, and the molar fraction of UF₄ will be increased to ~5%. In other cases, other chemistries and fuel salt are contemplated. One purpose of such research reactors is to provide data for validation of nuclear reactor modeling codes that would support the licensing of commercial reactors.

The NaNuC Simulation Tool may provide the neutronics calculations to support the licensing of research reactors, such as the MSRR, including criticality safety, startup physics testing, normal operation, source-term analysis, shielding and dosimetry throughout the facility, and data to support safety analysis calculations. Such neutronics calculations may entail over 10,000 fixed-source transport, eigenvalue transport, and depletion calculations at over 40 different reactor states (fuel location, temperature distribution, etc.).

In the present disclosure, the NaNuC Simulation Tool includes a software framework that models the given research reactor for intended support of Final Safety Analysis Report (FSAR), as part of an operating license, regarding research and development (R&D) and analyses. In one embodiment, SCALE code system produced by Oak Ridge National Laboratory (ORNL) is chosen as the primary licensing neutronic code. The SCALE calculations use a variety of sequences and codes, including k-eigenvalue 3D Monte Carlo (KENO) and 2D deterministic (NEWT) transport, fixed-source Monte Carlo source transport (MONACO), with deterministic transport (DENOVO) for variance reduction (MAVRIC) to improve statistics at detector locations, and isotopic depletion and decay (ORIGEN). The problems also included a range of temperatures and geometric conditions (rods in/out, fuel salt filled, drained, or draining), and optimization features.

In one embodiment, the software framework produces organized layered data and creates a plurality of SCALE input files that combines material, geometric, and analysis-specific settings. By changing these packets of data, different states of the reactor and different analyses can be generated. From this, the outputs of the SCALE can be parsed and organized into a uniform format, such as JSON5 format. The values in these JSON5 files will then be used as inputs for other teams in the MSRR licensing project, or as references for contents in the FSAR.

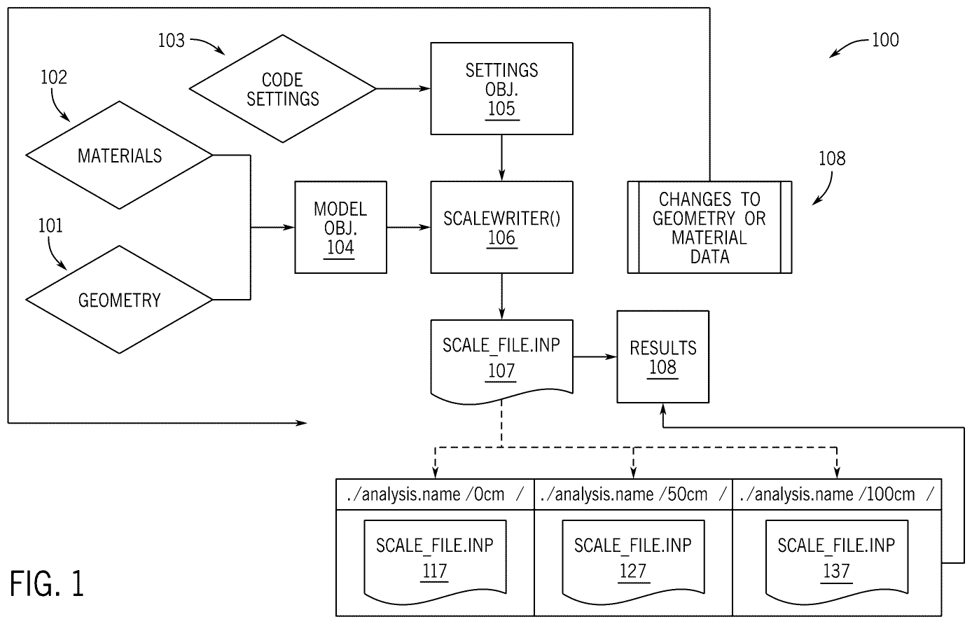

Turning to the drawings, for purposes of illustration, FIG. 1 illustrates an example process flow diagram showing analysis to yield neutronic results. As will be understood, the example shown in FIG. 1 represents merely one example implementation of the NaNuC Simulation Tool, in which an input file is generated for SCALE. It will be understood that the nuclear instrumentation described herein may be used in and with substantially any other implementations of the NaNuC Simulation Tool for other neutronics codes, as contemplated herein.

In certain embodiments, the NaNuC Simulation Tool may be a Python tool used to create neutronics inputs based on geometry and material data of the MSRR and code-specific settings. The research reactor may be represented using an object-oriented Python data tree structure. The data may be a set of nested objects oriented according to their relationship to the root object. The root object is the base level of the data tree, and all domain data branches from this point. This root object for the representation of the model is called the model object. As illustrated in FIG. 1, the model object 104 may be a localized data set describing the reactor in terms of geometry 101 and material 102 definitions. Similarly, a settings object 105 may be created to store the code specific settings 103 for generating the SCALE input file 107. The NaNuC Simulation Tool may be further configured to create the SCALE input file 107 by using ScaleWriter( ) 106. In particular, the model 104 and settings 105 objects may be used as input arguments for ScaleWriter( ) 106, so that ScaleWriter( ) can produce a SCALE single input file for a given model and settings configuration. The SCALE input file 107 is then used by the SCALE code for generating results based on the model and settings configuration of the reactor model. Alternatively, changes made in geometry 101, material 102, and code settings 103 can cause the NaNuC Simulation Tool to create the multiple parameterized SCALE input files 117, 127, 137, which correspond to different model and settings configurations.

Still referring to FIG. 1, the geometry data 101 represents the physical state of the reactor model. Geometry data 101 gives most of the structure to the model object 104. Starting from the root object, geometry data 10 may be first broken into components. Components are geometric features that may be interconnected and use similar materials. If necessary, these components can be represented as subcomponents based on the component's complexity and the data tree's desired organization. At the end level of this representation are objects called structures. These structures describe a simple volume or surface in the model, such as planes, cylinders, or pipes. The structure objects may take input definitions, such as dimensions and the relative local position, to extrapolate the necessary global positional data.

Materials 102 are distributed throughout the model object 104 as discrete packets of data. These data packets can be placed anywhere in the model object 104, but materials are usually placed in the component where they are used for organizational sake. For this model, solid materials are placed into a component that uses that material, and fluids are placed in the root. Further organization allows the materials to be placed in a MaterialGroup( ) object, which acts like a list of materials with dot reference notation.

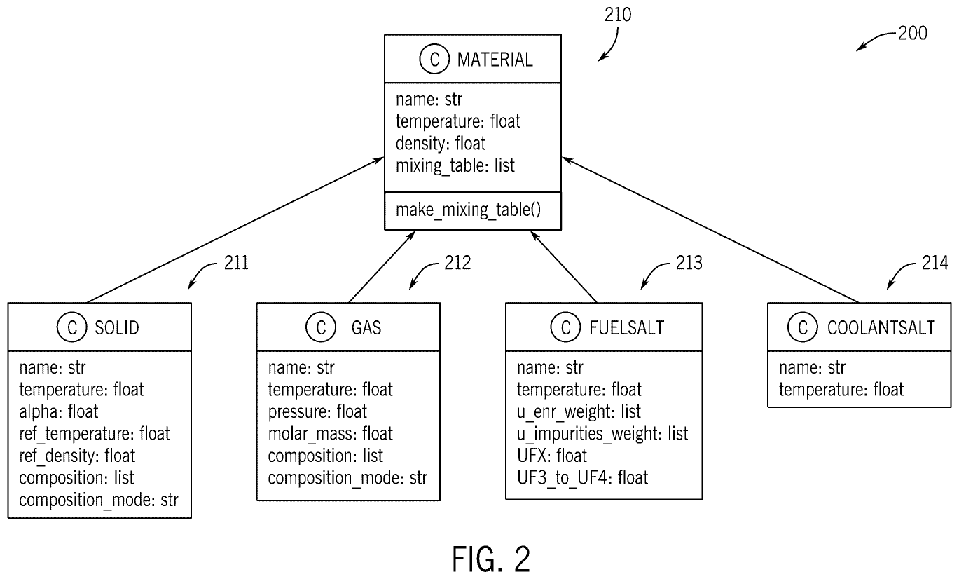

An individual material is an object which holds all relevant values that might be called from that material. In certain embodiments, the intended way to initialize this material object is by using subclasses that describe a material type. FIG. 2 shows some example material subclasses and their required input. For example, a material object 210 can include different material types, including solid 211, gas 212, fuel salt 213, and coolant salt 214. These material types are subclasses of the material object 210. In practice, the NaNuC Simulation Tool is configured to create a material object when one of the material types is constructed. Each material object can include different input arguments. As an example, material object Solid( ) 211 may include input arguments of name, temperature, alpha, ref_temperature, ref_density, composition, and composition mode. Material object Gas( ) 212 may include input arguments of name, temperature, pressure, molar_mass, composition, and composition mode. Material object FuelSalt( ) 213 may include input arguments of name, temperature, u_enr_weight, u_impurities_weight, UFX, and UF3_to_UF4. Material object CoolantSalt( ) 214 may include input arguments of name and temperature. These subclasses convert input data relevant to a type of material and initialize a generic material object. This is useful because methods shared between all materials only need to be developed once in the generic material object.

Building complex data structures, like this one, may require many boilerplate steps which can be alleviated with setter methods. These setters allow for consistent additions to the model while assuring that all the required setup steps are taken. For instance, the model has two major setters methods: add_mat( ) and add_comp( ).

The setter method add_mat( ) is configured to add a material object to the model object. This setter method can be given a destination for where the material should be added. Otherwise, the material will be placed in the root object's MaterialGroupd( ), which is called mat. Each component may also have this setter, allowing materials to be dispersed among the components. As a design decision, subcomponents may not have this setter if it is decided that materials should be unique only down to the component level. This means that all structures and subcomponents may share the same MaterialGroup( ) collection of material objects.

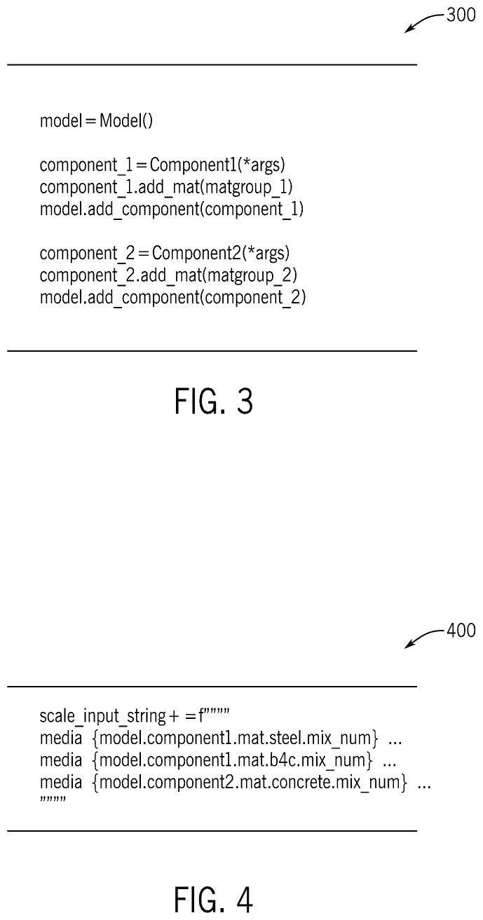

As shown in FIG. 3, the setter method add_comp( ) is configured to add a component to the model object. This setter method takes an initialized component and places it into the root object. This implementation minimizes data transfers between the components. Each component may have a similar setter to this one for applying subcomponents to a component.

Assigning the mixture numbers to the materials is an important role these methods accomplish. The mixture number is the reference number for the material and is used by SCALE to identify materials. Using a number to reference a material is useful when the number of materials is small. However, this becomes more difficult to track as the number of materials increases, as seen in real physical systems. In certain embodiments, each material object is assigned its own unique mixture number and the call for a mixture number is related to the position of the material in the model object. To make this happen, a master roster of material objects and mixture numbers may be created in the root object. This roster holds the references of each material and its mixture number material. This roster may be updated each time add_mat( ) method or add_comp( ) method is called, adding every material in the relevant MaterialGroup( ) to the roster. Once a mixture number is determined, the attribute called mix_num is added to the material. This mix_num attribute may be the integer SCALE identifier for that specific material. FIG. 4 shows how this integer could be called during the input string generation for SCALE.

SCALE is a collection of sequences (e.g., CSAS, TRITON, MAVRIC, etc.) that conduct neutronic calculations and analyses. Each sequence represents a distinct computational workflow that invokes a specific combination of physics modules, numerical solvers, and data-processing routines tailored to a particular class of analysis (e.g., criticality, shielding, or depletion). As a result, the structure and syntax of a SCALE input file are inherently dependent on the selected sequence, leading to a systematically inconsistent input format that reflects the different data requirements and interpretation rules of the underlying modules. Accordingly, it was necessary to create ScaleWriter( ) as a class with flexible individual sequence writers that could switch between local and shared methods. For instance, a shared method may produce a 3D geometry block and another one may produce a 2D geometry block. Meanwhile, the parameter blocks and tallies may be produced using the local sequence writer methods. To produce a SCALE input, the sequence writer may call these shared and private methods to produce a SCALE input and provide those methods with a data format they can read.

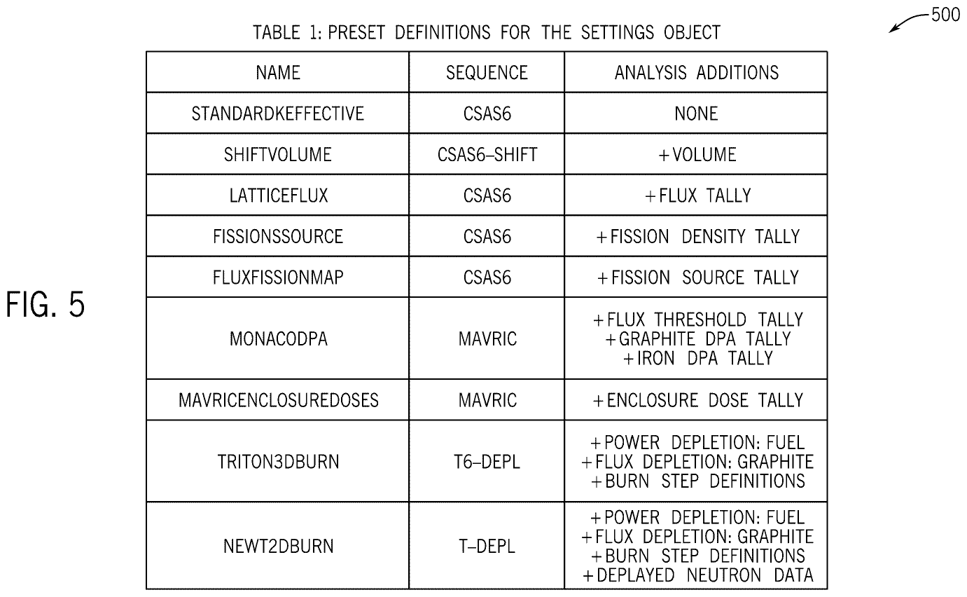

The development of data objects that can direct the writer's methods may be created similarly to how the model data is created. For instance, in certain embodiments, there is a root object called the settings object, and there are nested objects from which data can be pulled out. This data structure can be created progressively by deriving it from a required neutronic analysis, allowing for rapid incremental development. Due to requirements, apart from the licensing project, some analyses require complex SCALE inputs and, consequently, a complex representation. If these complex settings are generated or initialized on the fly, this could cause inconsistent errors. To address this problem, a collection of preset settings may be created. As illustrated in Table I of FIG. 5, these presets allow for consistent and uniform creation of desired cases. Each preset is related to the type of analysis that a single SCALE input should do. As a result, each analysis is organized so that any SCALE input related to that analysis will use the same preset. Presets mirror the data structure and internal inheritance in a SCALE input. These presets may define this data structure by using default values to fill fields in the settings object. This allows the user to change specific parts of the settings, deviating from the default values defined by the preset.

The SCALE input may be created through a get method in the ScaleWriter( ). As an example, the NaNuC Simulation Tool is configured to invoke the get method in the ScaleWriter( ) to create a string that holds the entire input and then saves it to a file for SCALE. From this, a method inside ScaleWriter( ) can produce the input file string in accordance with SCALE's syntax rules and save it into a directory system determined by the desired analysis. This can be done by initializing ScaleWriter( ), calling the get_deck( ) method, and then saving that string to a file. In particular, the get_deck( ) method may create the input file in accordance with SCALE's syntax rules. To keep high-performance computing (HPC) queuing script complexity to a minimum, all input files can be named the same “scale_file.inp” and be placed into an empty directory. This directory's name and location are the keys that identify the input file. For example, a directory may be called “nominal_keffective” and have a single SCALE input file.

For analyses that require multiple input files, such as control rod worth scan, ScaleWriter( ) preferably will be initialized each time for each input file. This is advantageous because the definition of the model object between each input file changes. ScaleWriter( ) may take this model object instance as an argument during setup. As a result, an outside scripting layer may be needed from the user to initialize multiple model objects in such a way that is reflective of the analysis. To capture the control rod worth, for example, the desired level of detail from a control rod worth curve may be ten data points from maximum to minimum insertion. In preferred embodiments, this means that ten model objects need to be generated, with the only difference between them being the specific control rod(s) position. These model objects are then fed into the same process to create a string for a single input analysis. This string may be saved to an input file in an empty directory system, which details the analysis and the meaning behind each input file.

Alternatively, the NaNuC Simulation Tool may include similar writers that are configured to generate input files in accordance with the syntax rules of other simulation tools or neutronics codes, including, but not limited to Serpent, OpenMC, MCNP.

For example, to generate an input for Serpent, the NaNuC Simulation Tool first builds the logical hierarchic representation of the reactor model (e.g., MSRR) and its state based on its geometry and material data, as well as code-specific settings for simulation parameters. The logical hierarchic representation can be achieved using an object-oriented Python data tree structure. This allows NaNuC Simulation Tool to construct data objects, such as the model object from the geometry and material data, and the settings object from the code-specific settings for simulation. Next, the NaNuC Simulation Tool may be configured to use a writer, such as SerpentWriter( ), to write the data objects into an input file for Serpent in accordance with the syntax rules of Serpent's input format. Since SerpentWriter( ) employs the same logical hierarchic representation, e.g., data objects, as ScaleWriter( ), the resulting Serpent's input file will replicate the reactor model configurations and preserve the hierarchical structure of the geometry and material data, as well as code-specific settings.

As another example, to generate an input for OpenMC, the NaNuC Simulation Tool first builds the logical hierarchic representation of the reactor model (e.g., MSRR) and its state based on its geometry and material data, as well as code-specific settings for simulation parameters. The logical hierarchic representation can be achieved using an object-oriented Python data tree structure. This allows NaNuC Simulation Tool to construct data objects, such as the model object from the geometry and material data, and the settings object from the code-specific settings for simulation. Next, the NaNuC Simulation Tool is configured to use a writer, such as OpenMCWriter( ), to write the data objects into an input file for Serpent in accordance with the syntax rules of OpenMC's input format. Since OpenMCWriter( ) employs the same logical hierarchic representation, e.g., data objects, as ScaleWriter( ) and SerpentWriter( ), the resulting OpenMC's input file will replicate the reactor model configurations and preserve the hierarchical structure of the geometry and material data, as well as code-specific settings.

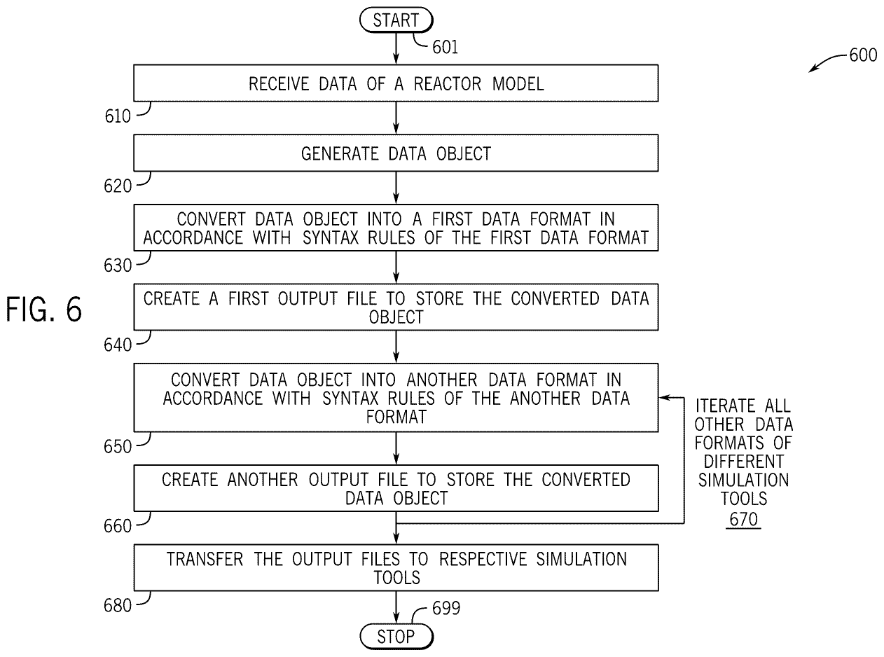

FIG. 6 depicts a flow diagram of an example process 600 for creating input files associated with different simulation tools on identical reactor model configurations, enabling efficient and accurate conversion of data objects into input files that conform to syntax rules of different simulation tools or neutronics codes. The process 600 starts with 601. At step 610, the NaNuC Simulation Tool is configured to receive data of a reactor model. As discussed in FIG. 1, the data of the reactor model includes geometry, material definitions, and code-specific setting, describing a particular geometric configuration, along with atom densities and temperatures of the materials involved in the MSRR for simulation.

At step 620, the NaNuC Simulation Tool is configured to generate data objects, such as model object and settings object. As discussed in FIGS. 1-5, the model object may include geometry and materials information of the reactor model (e.g., MSRR) and the settings object may include the code-specific preset definitions for simulation parameters. When creating the mode object and settings object, the NaNuC Simulation Tool is configured to establish a tree structure to represent relationships among the data entities for each of the objects. For example, the model object may be constructed as a data tree, wherein the root object is the base level and all domain data branches from this root object. Particularly, the NaNuC Simulation Tool is configured to define different components of a material object in the model object. The material object may contain Material as the root node and connect different material types (e.g., solid, gas, fuel salt, and coolant salt) as its nodes. Similarly, a geometry object in the model object may contain different components that represent different geometric features. These components may be interconnected with each other and use similar materials. At the end level of the geometry object, there are different structures that describe a simple volume or surface in the model, such as planes, cylinders, or pipes. The structure objects may take input definitions, such as dimensions and the relative local position, to extrapolate the necessary global positional data.

At step 630, the NaNuC Simulation Tool is configured to convert the data objects into a first data format, such as the one used in SCALE code system. Conventionally, converting data objects across different simulation tools or neutronics codes usually require manual intervention, custom scripting, or inefficient intermediary file formats, leading to increased computational overhead, errors, and incompatibility issues. The NaNuC Simulation Tool may overcome these limitations by automating and optimizing the data conversion process through a structured transformation mechanism. In particular, the NaNuC Simulation Tool may include a plurality of writers that correspond to different simulation tools or neutronics codes, such as ScaleWriter( ), SerpentWriter( ), OpenMCWriter( ), and MCNPWriter( ). For example, SCALE code system is considered as a primary simulation tool or neutronics code. When the NaNuC Simulation Tool is configured to generate data objects, such as defining a material object, at step 620, the SCALE code system is run to generate a list of nuclide densities for that material object. This list may represent the concentration of all nuclides in the material (e.g., Li-7 or U-235) per unit volume. Along with the corresponding temperature and thermal scattering treatment, this uniquely defines a material composition used in reactor models (e.g., MSRR). In addition, each material definition list, such as the list of nuclide densities, is also cached using its hash in a database to avoid wasting computational time when the same material is encountered again. If NaNuC already “knows” the material, it retrieves the list directly from the cache.

The NaNuC Simulation Tool then parses the material's list of nuclide densities and other data blocks from the objects, encoding them into a first data format that the SCALE code system can understand. For example, the NaNuC Simulation Tool may use ScaleWriter( ) to convert the data blocks into a first data format based on SCALE's syntax rules. During this conversion process, the NaNuC Simulation Tool may automatically analyze and restructure the parsed data blocks according to SCALE's syntax rules. It may evaluate these rules, apply rule-based modifications, and generate syntactically correct data for the SCALE input file.

At step 640, the NaNuC Simulation Tool is configured to create an output file to store the converted data objects. The output file is also the input file used in SCALE for simulation. At this step, the NaNuC Simulation Tool is configured to write the converted data objects into the output file based on the syntax rules of SCALE input file and validate the output format to ensure it is in accordance with syntax constraints.

At step 650, the NaNuC Simulation Tool is configured to convert the data objects into another data format, which is different from the first data format. For example, the NaNuC Simulation Tool can convert the data objects into a data format used in Serpent code system. Like the step 630, the NaNuC Simulation Tool may use a writer, such as SerpentWriter( ), to parse the material's list of nuclide densities and other data blocks from the objects, encoding them into a data format that the Serpent code system can understand based on Serpent's syntax rules. During this conversion process, the NaNuC Simulation Tool may automatically analyze and restructure the parsed data blocks according to Serpent's syntax rules. It may evaluate these rules, apply rule-based modifications, and generate syntactically correct data for the Serpent input file.

At step 660, the NaNuC Simulation Tool is configured to create an output file to store the converted data objects for Serpent. The output file is also the input file used in Serpent for simulation. At this step, the converted data objects can be written into the output file based on the syntax rules of Serpent. At this step, the NaNuC Simulation Tool is configured to write the converted data objects into the output file based on the syntax rules of Serpent input file and validate the output format to ensure it is in accordance with syntax constraints.

At step 670, if there are other simulation tools or neutronic codes available, the NaNuC Simulation Tool can convert the data objects into the respective data format of the simulation tool or neutronic code, such as OpenMC or MCNP. In particular, the NaNuC Simulation Tool is configured to iterate the steps 650-660 to convert the data objects and generate the output files in accordance with the syntax rules of other simulation tools.

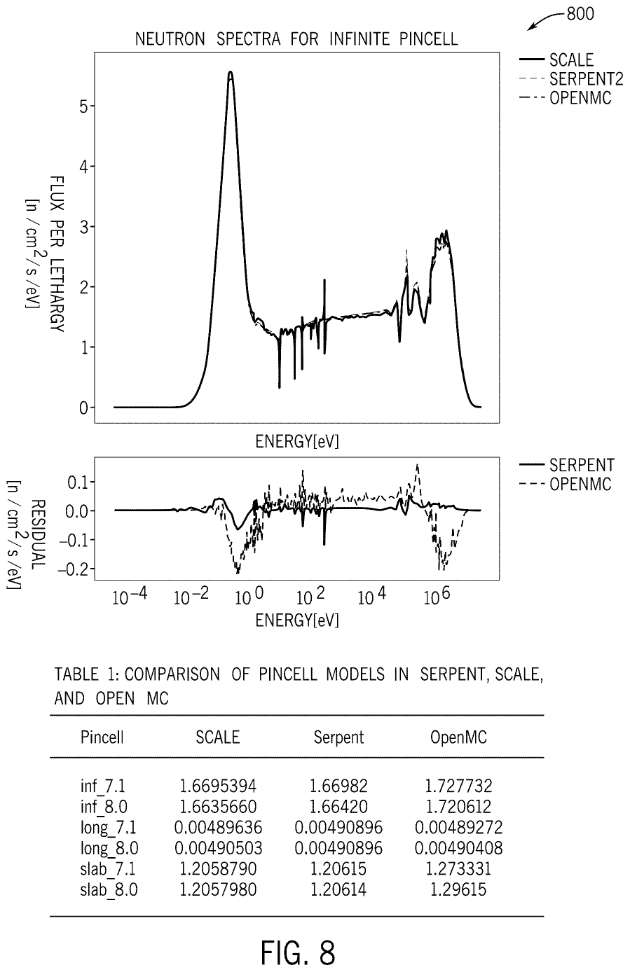

At step 680, the NaNuC Simulation Tool is configured to transmit the output files to different simulation tools or neutronic codes, so that each of the simulation tools or neutronic codes can run the simulation based on the identical configurations and parameters of the reactor model (e.g., MSRR). In this way, the NaNuC Simulation Tool can perform code-to-code comparisons of neutronics results using SCALE, Serpent, and OpenMC with the same inputs, down to machine precision, of geometries, temperatures, and nuclide densities. FIG. 8 is an example flux comparison figure and a comparison of Pincell Models in Serpent, SCALE, and OpenMC. The process 600 then stops at step 699.

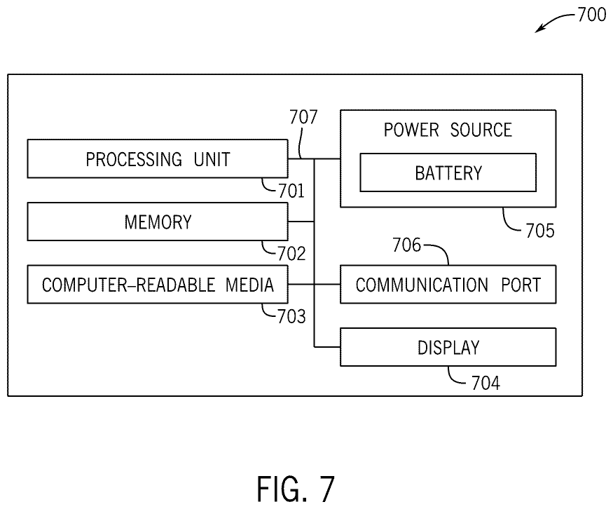

FIG. 7 depicts a functional block diagram of a computing system 700 for the NaNuC Simulation Tool. The schematic representation in FIG. 7 is generally representative of any type of system or configuration that may be used to receive and process the various signals from the NI and sensors described herein. For example, the computing system 700 may be used with or included within the NaNuC Simulation Tool, and to perform any of the functions described herein. In this regard, the computing system 700 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

As shown in FIG. 7, the computing system 700 may include a processing unit or element 701 operatively connected to computer memory 702 and computer-readable media 703. The processing unit 701 may be operatively connected to the memory 702 and computer-readable media 703 components via an electronic bus or bridge (e.g., such as system bus 707). The processing unit 701 may include one or more computer processors or microcontrollers that are configured to perform operations in response to computer-readable instructions. The processing element 701 may be a central processing unit of the computing system 700. Additionally or alternatively, the processing unit 701 may be other processors within the device including application specific integrated chips (ASIC) and other microcontroller devices.

The memory 702 may include a variety of types of non-transitory computer-readable storage media, including, for example, read access memory (RAM), read-only memory (ROM), erasable programmable memory (e.g., EPROM and EEPROM), or flash memory. The memory 702 is configured to store computer-readable instructions, sensor values, and other persistent software elements. Computer-readable media 703 may also include a variety of types of non-transitory computer-readable storage media including, for example, a hard-drive storage device, a solid state storage device, a portable magnetic storage device, or other similar device. The computer-readable media 703 may also be configured to store computer-readable instructions, sensor values, and other persistent software elements.

In this example, the processing unit 701 is operable to read computer-readable instructions stored on the memory 702 and/or computer-readable media 703. The computer-readable instructions may adapt the processing unit 701 to perform the operations or functions described above with respect to FIGS. 1-6. The computer-readable instructions may be provided as a computer-program product, software application, or the like.

As shown in FIG. 7, the computing system 700 may also include a display 704. The display 704 may include a liquid-crystal display (LCD), organic light emitting diode (OLED) display, light emitting diode (LED) display, or the like. If the display 704 is an LCD, the display may also include a backlight component that can be controlled to provide variable levels of display brightness. If the display 704 is an OLED or LED type display, the brightness of the display 704 may be controlled by modifying the electrical signals that are provided to display elements.

The computing system 700 may also include a battery that is configured to provide electrical power to the components of computing system 700. The battery may include one or more power storage cells that are linked together to provide an internal supply of electrical power. In this regard, the battery may be a component of a power source 705 (e.g., including a charging system or other circuitry that supplies electrical power to components of the computing system 700). The battery may be operatively coupled to power management circuitry that is configured to provide appropriate voltage and power levels for individual components or groups of components within the computing system 700. The battery, via power management circuitry, may be configured to receive power from an external source, such as an AC power outlet or interconnected computing device. The battery may store received power so that the computing system 700 may operate without connection to an external power source for an extended period of time, which may range from several hours to several days.

The computing system 700 may also include a communication port 706 that is configured to transmit and/or receive signals or electrical communication from an external or separate device. For example, in the present disclosure, the computing system 700 is configured to transmit and/or receive signals or electrical communication representing geometry and material definitions, as well as code-specific settings for simulation parameters. The communication port 706 may be configured to couple to an external device via a cable, adaptor, or other type of electrical connector. In some embodiments, the communication port 706 may be used to couple the computing system 700 with a computing device and/or other appropriate accessories configured to send and/or receive electrical signals. The communication port 706 may be configured to receive identifying information from an external accessory, which may be used to determine a mounting or support configuration. For example, the communication port 706 may be used to determine that the computing system 700 is coupled to a mounting accessory, such as a particular type of stand or support structure.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A computer-implemented method for nuclear reactor simulation, the method comprising:
receiving, via an input interface, a plurality of objects describing geometry data and material data associated with a plurality of components in a nuclear reactor model;
generating, via a processor, a hierarchical tree structure comprising:
a plurality of nodes representing the plurality of objects, each node storing geometry data and material data associated with a respective component of the nuclear reactor model;
a plurality of parent-child relationships between the plurality of nodes representing relationships between the plurality of components;
converting, by the processor, the hierarchical tree structure into a first data format by
parsing the geometry data and the material data throughout the hierarchical tree structure;
encoding the geometry data and the material data based on syntax associated with the first data format;
generating, by the processor, a first output file containing the encoded geometry data and the material data;
converting, by the processor, the hierarchical tree structure into a second data format by
parsing the geometry data and the material data throughout the hierarchical tree structure;
encoding the geometry data and the material data based on syntax associated with the second data format;
wherein the syntax associated with the second data format is different from the syntax associated with the first data format;
generating, by the processor, a second output file containing the encoded geometry data and the material data; and
transmitting, via an output interface, the first output file to a first nuclear reactor simulation tool and the second output file to a second nuclear reactor simulation tool.

2. The computer-implemented method of claim 1, further comprising
converting, by the processor, the hierarchical tree structure into a third data format by
parsing the geometry data and the material data throughout the hierarchical tree structure;
encoding the geometry data and the material data based on syntax associated with the third data format;
wherein the syntax associated with the third data format is different from the syntax associated with the first data format and the syntax associated with the second data format;
generating, by the processor, a third output file containing the encoded geometry data and the material data.

3. The computer-implemented method of claim 1, wherein the first data format is compatible with an input file of SCALE.

4. The computer-implemented method of claim 1, wherein the second data format is compatible with an input file of Serpent.

5. The computer-implemented method of claim 2, wherein the third data format is compatible with an input file OpenMC.

6. A system for facilitating nuclear reactor simulation, the system comprising:
an input interface configured to receive a plurality of objects describing geometry data and material data associated with a plurality of components in a nuclear reactor model;
one or more processors; and
a memory storing instructions that, when executed by the one or more processors, cause the one or more processors to:
generate a hierarchical tree structure comprising:
a plurality of nodes representing the plurality of objects, each node storing geometry data and material data associated with a respective component of the nuclear reactor model; and
a plurality of parent-child relationships between the plurality of nodes representing relationships between the plurality of components;
convert the hierarchical tree structure into a first data format by
parsing the geometry data and the material data throughout the hierarchical tree structure; and
encoding the geometry data and the material data based on syntax associated with the first data format;
generate a first output file containing the encoded geometry data and the material data;
convert the hierarchical tree structure into a second data format by
parsing the geometry data and the material data throughout the hierarchical tree structure; and
encoding the geometry data and the material data based on syntax associated with the second data format, wherein the syntax associated with the second data format is different from the syntax associated with the first data format;
generate a second output file containing the encoded geometry data and the material data; and
transmit, via an output interface, the first output file to a first nuclear reactor simulation tool and the second output file to a second nuclear reactor simulation tool.

7. The system of claim 6, wherein the instructions further cause the one or more processors to:
convert the hierarchical tree structure into a third data format by
parsing the geometry data and the material data throughout the hierarchical tree structure; and
encoding the geometry data and the material data based on syntax associated with the third data format, wherein the syntax associated with the third data format is different from the syntax associated with the first data format and the syntax associated with the second data format; and
generate a third output file containing the encoded geometry data and the material data.

8. The system of claim 6, wherein the first data format is compatible with an input file of SCALE.

9. The system of claim 6, wherein the second data format is compatible with an input file of Serpent.

10. The system of claim 7, wherein the third data format is compatible with an input file of OpenMC.

11. A non-transitory computer-readable medium storing instructions that, when executed by one or more processors, cause the one or more processors to perform the method of claim 1.

12. The non-transitory computer-readable medium of claim 11, wherein the instructions further cause the one or more processors to perform the method of claim 2.

13. The non-transitory computer-readable medium of claim 11, wherein the first data format is compatible with an input file of SCALE.

14. The non-transitory computer-readable medium of claim 11, wherein the second data format is compatible with an input file of Serpent.

15. The non-transitory computer-readable medium of claim 12, wherein the third data format is compatible with an input file of OpenMC.
